(19) United States
(12) Patent Application Publication
(10) Pub. No.: US 2017/0089841 A1
(43) Pub. Date: Mar. 30, 2017

(54) INSPECTION APPARATUS AND ARTICLE MANUFACTURING METHOD

(71) Applicant: CANON KABUSHIKI KAISHA, Tokyo (JP)

(72) Inventor: Takanori Uemura, Saitama-shi (JP)

(21) Appl. No.: 15/277,899

(22) Filed: Sep. 27, 2016

(30) Foreign Application Priority Data
Sep. 30, 2015 (JP) 2015-194024

(51) Int. Cl. G01N 21/88; G06T 5/00; G01N 21/892; G06T 7/00

(52) U.S. Cl. CPC G01N 21/8806; G06T 7/0004; G06T 5/007; G01N 21/892; G06T 2207/10152; G06T 2207/10004; G06T 2207/30108; G01N 2021/8924

(57) ABSTRACT

An inspection apparatus for performing inspection of an object includes an illumination device, an imaging device, and a processor. The illumination device performs an anisotropic illumination and an isotropic illumination for the object. The imaging device images the object illuminated by the illumination device. The processor performs processing for the inspection of the object based on an image obtained by the imaging device. The processor generates an inspection image based on (i) plural first images obtained by the imaging device while the illumination device respectively performs plural anisotropic illuminations and (ii) a second image obtained by the imaging device while the illumination device performs an isotropic illumination, and performs the processing based on the inspection image.

### BACKGROUND OF THE INVENTION

Field of the Invention

The present invention relates to an inspection apparatus for inspecting an object, and an article manufacturing method.

Description of the Related Art

Appearance inspection of an object (e.g., a work), for example, is conducted recently using an inspection apparatus on the basis of an image acquired by imaging an illuminated object, instead of conventional inspection methods of viewing the object with the human eye. As an illumination system applicable to an inspection apparatus, a system in which independently controllable light sources are arranged in a dome shape is proposed (Japanese Patent Laid-Open No. 7-294442).

Further, an inspection apparatus which acquires plural images by independently turning on plural light sources disposed around an object, and inspects the object on the basis of an inspection image acquired by composing the plurality of images is proposed (Japanese Patent Laid-Open No. 2014-215217).

The illumination system disclosed in Japanese Patent Laid-Open No. 7-294442 may acquire an image under various illumination conditions, but may be disadvantageous in time required for the inspection of an object since it takes much processing time to acquire and process a great number of images.

The inspection apparatus disclosed in Japanese Patent Laid-Open No. 2014-215217 illuminates the object from plural azimuth angles to acquire plural images, generates an inspection image on the basis of either the maximum value or the minimum value of a pixel value for each pixel number, and inspects the inspection image for flaws. In this inspection apparatus, however, such defects as unevenness and a light absorptive contaminant (foreign substance), which are not a linear flaw or defect (scratch), may be difficult to detect because a difference in illumination azimuths in signals about the defects is not clear.

### SUMMARY OF THE INVENTION

The present invention provides, for example, an inspection apparatus advantageous in inspection of various defects.

An aspect of the present invention is an inspection apparatus for performing inspection of an object, the apparatus including: an illumination device configured to perform anisotropic illumination and isotropic illumination for the object; an imaging device configured to image the object illuminated by the illumination device; and a processor configured to perform processing of the inspection based on an image obtained by the imaging device, wherein the processor is configured to generate an inspection image based on plural first images obtained by the imaging device while the illumination device respectively performs plural anisotropic illuminations and a second image obtained by the imaging device while the illumination device performs an isotropic illumination, and perform the processing based on the inspection image.

Further features of the present invention will become apparent from the following description of exemplary embodiments with reference to the attached drawings.

### BRIEF DESCRIPTION OF THE DRAWINGS

FIG. 1 illustrates an exemplary configuration of an inspection apparatus.

FIGS. 2A and 2B illustrate an exemplary configuration of an illumination device.

FIG. 3 illustrates a processing flow of inspection.

FIG. 4 illustrates a processing flow of illumination and imaging.

FIGS. 5A to 5H illustrate illumination conditions by an illumination device.

FIGS. 6A to 6H are schematic diagrams illustrating images acquired for each illumination condition about an object having a defect.

FIGS. 7A and 7B are schematic diagrams illustrating intermediate images.

FIG. 8 is a schematic diagram illustrating an inspection image.

### DESCRIPTION OF THE EMBODIMENTS

Hereafter, embodiments of the present invention is described with reference to the drawings. In the drawings, the same components are denoted by the same reference numerals generally (unless otherwise stated) and repeated description thereof is omitted.

### First Embodiment

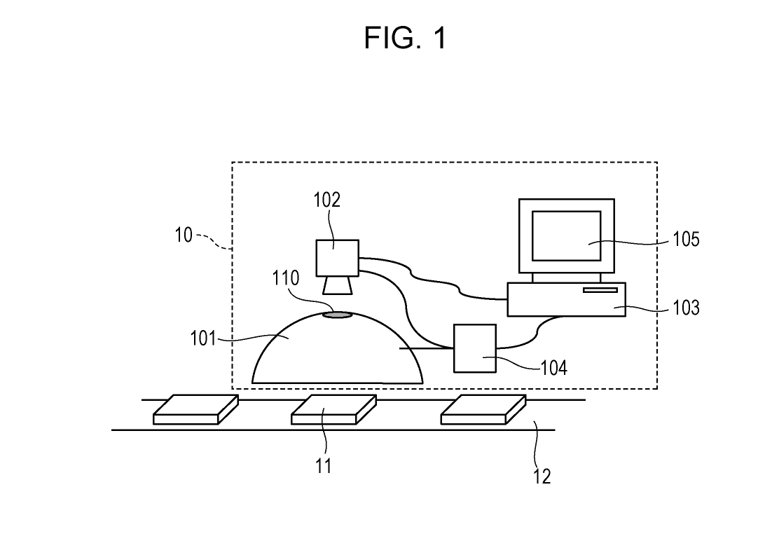

FIG. 1 illustrates an exemplary configuration of an inspection apparatus 10. The inspection apparatus 10 inspects an appearance of a work 11 as an object (an object to be inspected). However, the object to be inspected is not limited to the appearance of the work 11 but may be characteristics of the object which are invisible to the human eye (surface roughness, for example). The inspection apparatus 10 here may inspect the work 11 conveyed by a conveyor 12 as a conveyance unit. The work 11 may be a metal part, a resin part, and the like used for an industrial product, for example. On a surface of the work 11, there may be a defect, such as a linear flaw (scratch), unevenness (e.g., two-dimensional unevenness of light reflex characteristics depending on the surface roughness, the constituent, the film thickness, and the like, a non-linear or an isotropic flaw, a dent, and the like on the surface), and a light absorptive contaminant (foreign substance). The inspection apparatus 10 inspects such a defect and processes the work 11 (for example, sorts the work 11 as a non-defective object or a defective object). The conveyor 12, as the conveyance unit, may be substituted by a robot, a manual operation, and the like.

The inspection apparatus 10 may include an illumination device 101, an imaging device 102, a processor 103 (which may be constituted by a PC), a control unit 104, a display unit 105, an input unit (not illustrated), and the like. The control unit 104 controls the illumination device 101 and the imaging device 102 in synchronization with each other on the basis of an illumination pattern and an imaging pattern set in advance by the processor 103, for example. An opening 110 is formed at a top portion of the illumination device 101 so that the work 11 may be imaged by the imaging device 102. The imaging device 102 is constituted by a camera body, an optical system for imaging the work 11 on an image pickup device in the camera body, and the like, and an image acquired by imaging is transferred (transmitted) to the processor 103. The processor 103 is not necessarily a general-purpose PC but may be a dedicated device. The processor 103 and the control unit 104 may be formed integrally with each other. The processor 103 conducts processing for inspection of the work 11 on the basis of the image (i.e., data) transferred from the imaging device 102 (for example, detects a defect on the surface (i.e., an appearance) of the work 11). The processor 103 may conduct the processing on the basis of a tolerable condition with respect to a pixel value of a later-described inspection image. The display unit 105 displays information, including the image and the inspection result, transmitted from the processor 103. The input unit is constituted by a keyboard and a mouse, for example, and transmits input information and the like input by a user to the processor 103.

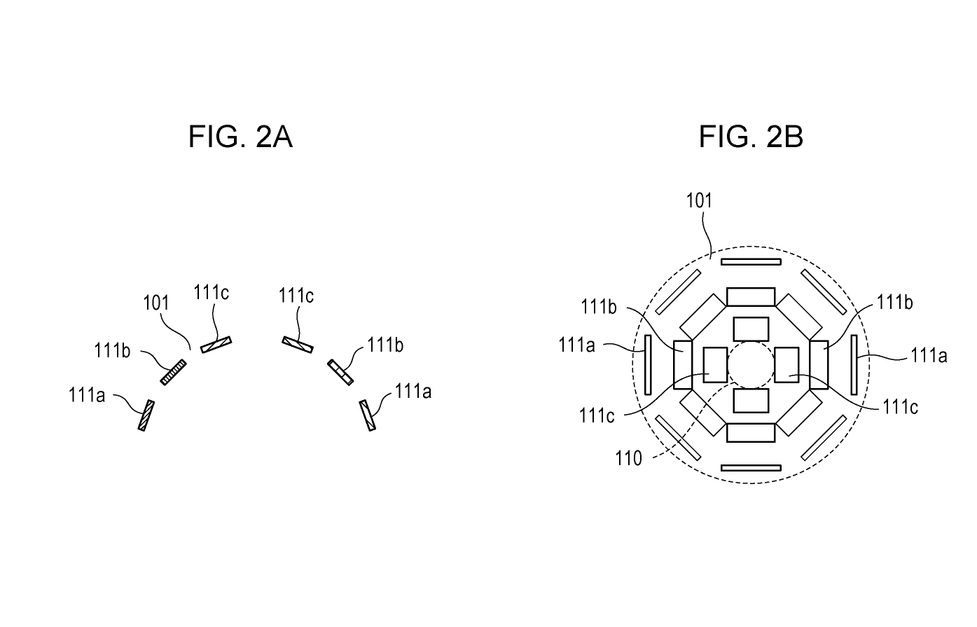

FIGS. 2A and 2B illustrate an exemplary configuration of the illumination device 101. FIG. 2A is a cross-sectional view of the illumination device 101 and FIG. 2B is a perspective view of the illumination device 101 seen from above. The illumination device 101 includes a total of 20 light emitting sections or light sources (hereafter, “LEDs”) 111. The light emitting section is not limited to the LED but may be other light sources, such as fluorescent light and mercury arc light. The LEDs 111 may be configured by arranging plural shell type or surface mounting type LED elements on a planar substrate, this configuration is not restrictive. Alternatively, for example, the LED elements may be arranged on a flexible board. This configuration may be advantageous to increase an emission area in a dome-shaped illumination device 101. The LEDs 111 may control the light amount and the light-emitting timing independently by the control unit 104. The LEDs 111 are disposed at three different elevations. An LED 111a illuminates the work 11 at a low elevation, an LED 111b illuminates the work 11 at a middle elevation, and an LED 111c illuminates the work 11 at a high elevation. Along the circumferential direction of the illumination device 101, eight LEDs 111a, eight LEDs 111b, and four LEDs 111c are provided. By turning on the predetermined LEDs 111 sequentially and making the imaging device 102 conduct imaging in synchronization with the turning on of the LEDs 111, an image may be acquired while the work 11 is illuminated under various illumination conditions (i.e., elevations, azimuth angles). The number and arrangement of the LEDs are not limited to those described above. It is only necessary to mount the LEDs on the illumination device 101 in the required number and arrangement depending on a type of the object to be inspected, a type of characteristics (defects) of the object to be inspected, and the like.

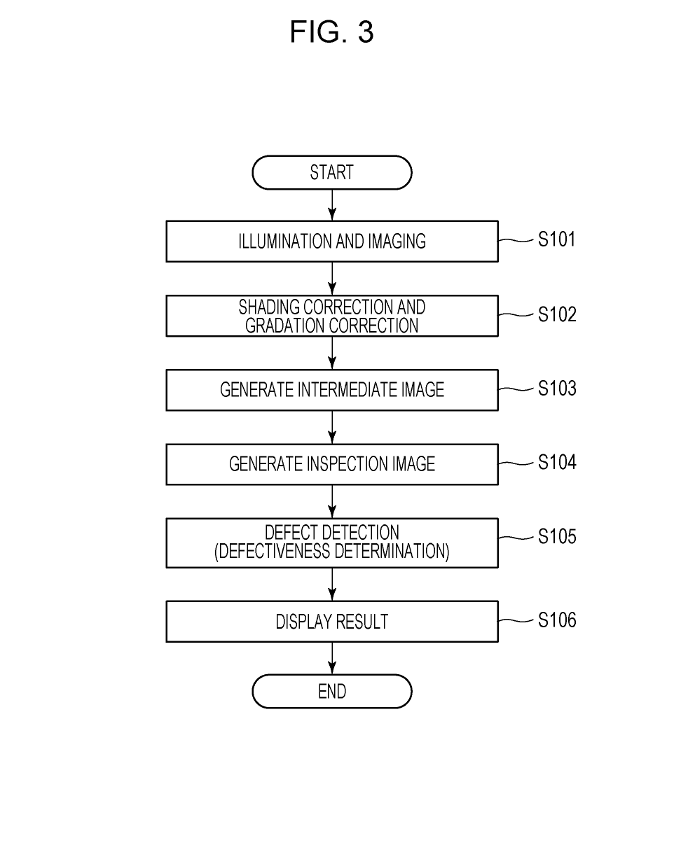

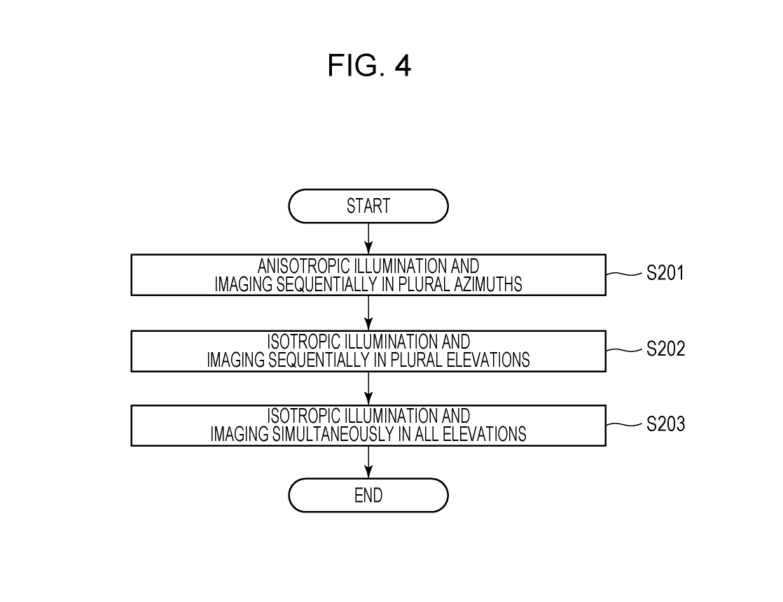

FIG. 3 illustrates a processing flow of inspection by the inspection apparatus 10. In FIG. 3, the work 11 is illuminated and imaged first (step S101). The processing of step S101 is described in detail with reference to FIGS. 4, 5A to 5H, and 6A to 6H. FIG. 4 illustrates a processing flow of illumination and imaging. In FIG. 4, anisotropic illumination and imaging are first conducted sequentially about plural azimuths (step S201). The term “anisotropy” here is used not about the “elevation” but about the “azimuth.” Specifically, the illumination device 101 and the imaging device 102 are controlled via the control unit 104 so that the LEDs 111 disposed at various azimuth angles and elevations are turned on sequentially and the work 11 is imaged by the imaging device 102 in synchronization with the turning on of the LEDs 111 in a predetermined manner.

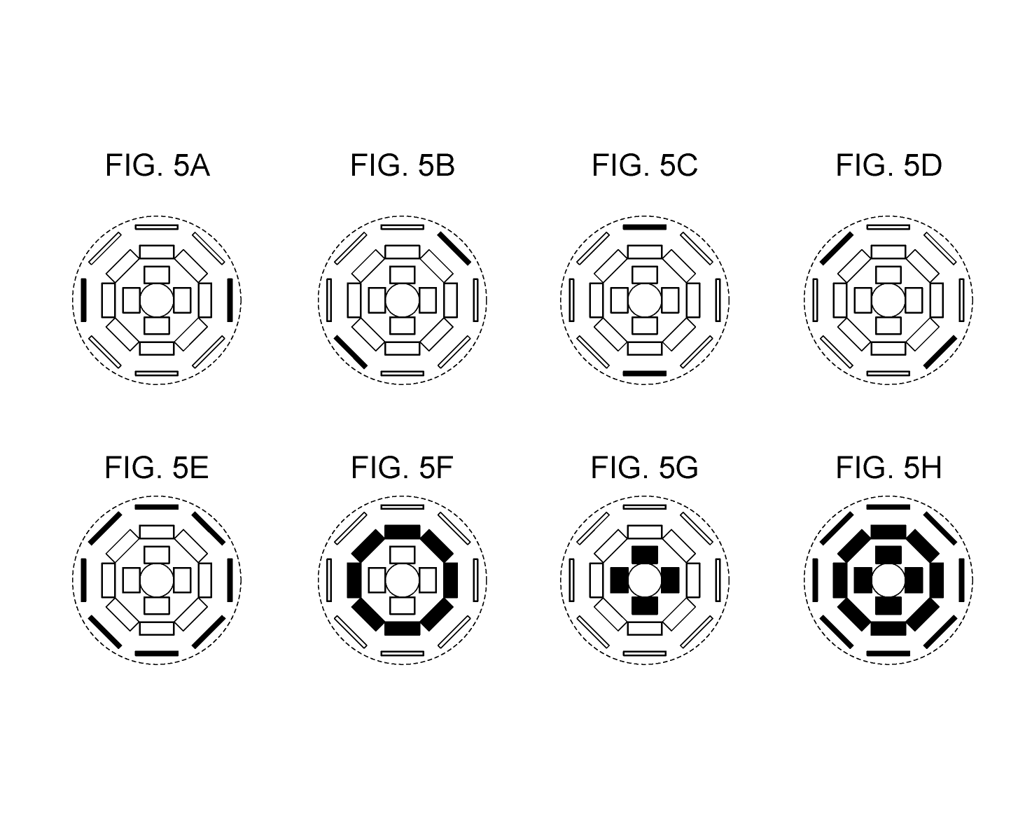

FIGS. 5A to 5H illustrate illumination conditions by the illumination device 101. The LEDs filled in black are in the lighting state and the LEDs filled in white are not in the lighting state. FIGS. 5A to 5D illustrate illumination patterns in step S201. Regarding the LEDs 111a disposed at the lowest elevation, two mutually facing LEDs are turned on simultaneously to illuminate the work 11 sequentially from different four azimuths (angles). A total of four images are thus acquired. The azimuth angle of illumination is 0° in FIG. 5A, 45° in FIG. 5B, 90° in FIG. 5C, and 135° in FIG. 5D. Although two mutually facing LEDs disposed at the lowest elevation are turned on simultaneously here, this configuration is not restrictive, but LEDs adjoining to these LEDs may further be turned on simultaneously. In this manner, anisotropic illumination and imaging are conducted sequentially about plural azimuths.

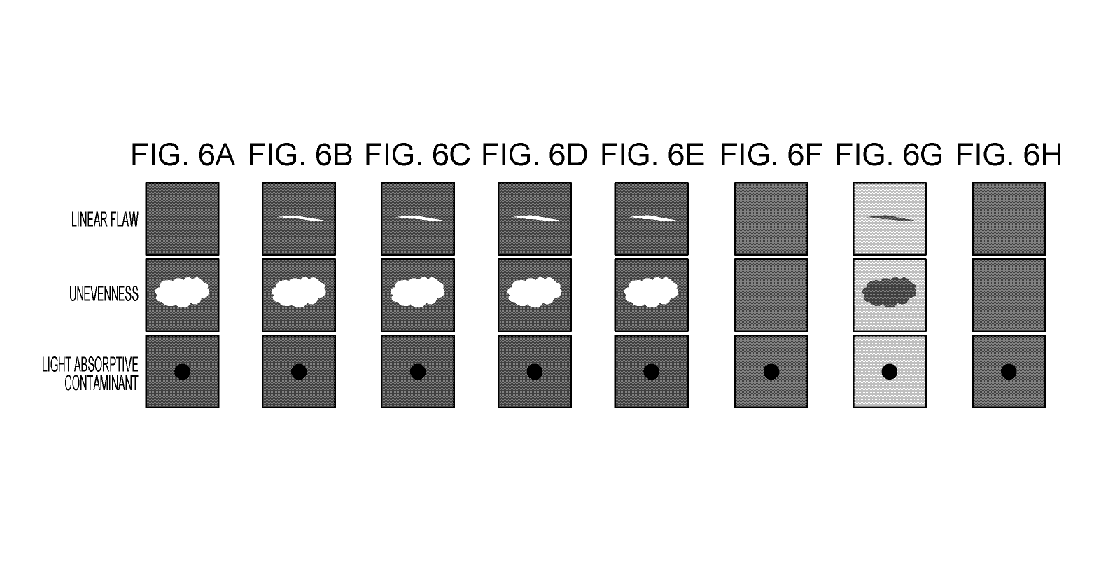

FIGS. 6A to 6H are schematic diagrams illustrating images acquired for each illumination condition about the object having a defect. The images acquired under the illumination conditions of FIGS. 5A to 5H correspond to FIGS. 6A to 6H, respectively. FIGS. 6A to 6H illustrate images in cases where a linear flaw (scratch), unevenness, or a light absorptive contaminant (foreign substance) exists on the surface of the work 11 as a defect. If a linear flaw exists in the work 11, as illustrated in FIGS. 6A to 6D, the appearance of the flaw (i.e., the contrast) changes depending on the illumination azimuth (angle). If the linear flaw is illuminated from an azimuth substantially parallel thereto (azimuth angle: 0°), the flaw is not visualized clearly on the image. If the linear clack is illuminated from an azimuth perpendicular thereto (azimuth angle: 90°), the flaw is visualized clearly on the image. This is because a cross-sectional shape of the linear flaw differs significantly depending on the azimuth, and a greater amount of reflected light or scattered lights from the flaw proceeds to the imaging device 102 when the linear flaw is illuminated from the azimuth perpendicular thereto. In the case of the unevenness or the light absorptive contaminant, unlike the linear flaw, the cross-sectional shape does not differ so much depending on the azimuth. Therefore, as illustrated in FIGS. 6A to 6D, the appearance (i.e., the contrast) of the defect on the image does not change so much depending on the illumination azimuth.

Next, isotropic illumination and imaging are conducted sequentially about plural elevations (step S202). The term “isotropy” here is used not about “elevation” but about “azimuth” as in “anisotropy.” Specifically, the illumination device 101 and the imaging device 102 are controlled via the control unit 104 so that the LEDs 111 disposed at plural elevations are turned on sequentially, and the work 11 is imaged by the imaging device 102 in synchronization with the turning on of the LEDs 111. FIGS. 5E to 5G illustrate illumination patterns in step S202. Regarding the LED 111a, the LED 111b and the LED 111c, the LEDs at the same elevation is turned on simultaneously, the work 11 is illuminated sequentially at three different elevations, and a total of three images are acquired. Regarding the elevations of illumination, FIG. 5E illustrates a low angle, FIG. 5F illustrates a middle angle, and FIG. 5G illustrates a high angle. The amount of reflected light or scattered light which proceeds to the imaging device 102 depends on the scatterability of the surface of the work 11 and changes with the elevation of illumination. Therefore, the LED 111a, the LED 111b and the LED 111c may be set to have mutually different light amount values so that the pixel values of the optimal image may be acquired.

The images acquired under the illumination conditions of FIGS. 5E to 5G correspond to FIGS. 6E to 6G, respectively. If the work 11 has a linear flaw, as illustrated in FIGS. 6E to 6G, an appearance (i.e., a feature) of the flaw changes depending on the elevation of illumination. If the flaw is illuminated at a low angle, the flaw is visualized brighter than a background level on the image. If the flaw is illuminated at a high angle, the flaw is visualized darker than the background level on the image. If the flaw is illuminated at a middle angle, however, the flaw is not visualized clearly. A surface of the work 11 at which the flaw is formed inclines as compared with surfaces of non-defective parts. Therefore, in the low angle illumination, a greater amount of scattered light from the flaw than the scattered light from the non-defective parts proceeds to the imaging device 102. In the high angle illumination, a smaller amount of scattered light from the flaw than the scattered light from non-defective parts proceeds to the imaging device 102. An appearance of the unevenness on the image changes with the elevation of illumination as in the case of the linear flaw. Unlike the linear flaw or the unevenness, the light absorptive (i.e., light absorbing) contaminant (foreign substance) absorbs light when illuminated from any of the elevations. Therefore, the light absorptive contaminant is visualized dark on the image and of which appearance does not change so much depending on the elevation.

Next, isotropic illumination and imaging are conducted simultaneously about all the elevations (S203). FIG. 5H illustrates a illumination pattern in step S203. An image is acquired with all the LEDs turned on simultaneously. The light amount of each LED may be the same or different. It is not necessary to turn all the LEDs on, or it is not necessary to turn a relatively smaller number of LEDs on. An image acquired under the illumination condition of FIG. 5H corresponds to FIG. 6H. Since brightness and darkness of the linear flaw and the unevenness are reversed in the low angle illumination and in the high angle illumination, both of the linear flaw and the unevenness are not visualized sufficiently when the low angle illumination and the high angle illumination are conducted simultaneously. Since the light absorptive contaminant absorbs light when illuminated from any of the elevations, the light absorptive contaminant is visualized dark even if all the LEDs are turned on simultaneously.

Returning to FIG. 3, in step S102, the processor 103 conducts shading correction and gradation correction on the image acquired by the imaging device 102. The shading correction makes the pixel value broadly uniform and the gradation correction sets the uniform level of the pixel value to be a predetermined value. Therefore, the image becomes an image suitable to generate the later-described inspection image. As illustrated in FIGS. 6E to 6G, the uniformity and level of the image acquired by imaging may vary depending on the elevation of illumination. The uniformity and level are corrected by the shading correction and the gradation correction.

The shading correction may be conducted with an original image being divided by the result obtained in advance by fitting a polynomial into a reference image. Further, the shading correction may be conducted with an original image being divided by an average value obtained in advance about plural images acquired by imaging each of plural non-defective works 11 (non-defective objects). The gradation correction may be conducted so that (a representative value (e.g., an average value) of) the pixel value related to a predetermined part (e.g., a part corresponding to the work 11) in the original image becomes a predetermined value.

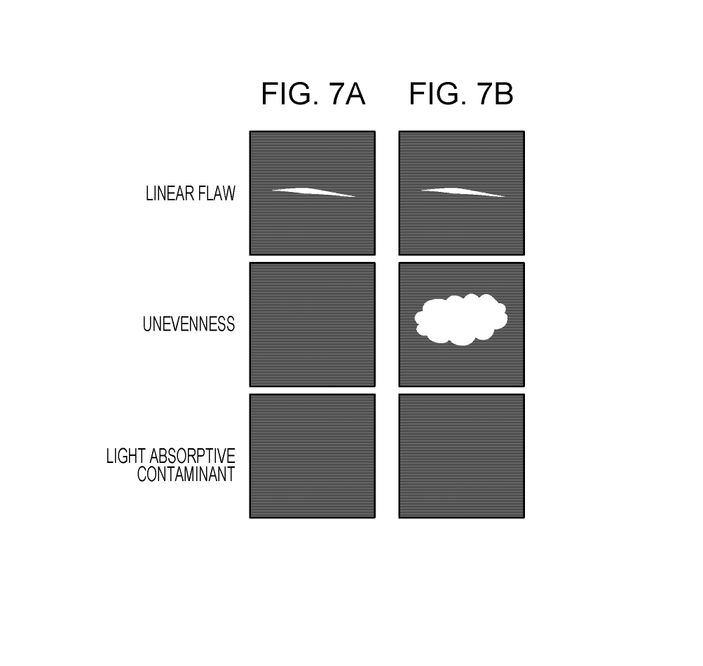

Next, the processor 103 generates an intermediate image from plural images acquired by the shading correction and the gradation correction (step S103). FIGS. 7A and 7B are schematic diagrams illustrating the intermediate image. FIG. 7A is an intermediate image generated by the processor 103 from the four images of FIGS. 6A to 6D via the shading correction and the gradation correction. The intermediate image is generated by obtaining a difference between the maximum pixel value and the minimum pixel value in the pixel group (4 pixels) related to the four images about each pixel (a pixel number or a pixel ID). The pixel value in the non-defective area of the work 11 does not change so much depending on the illumination azimuth. The pixel value in the area of the linear flaw, as illustrated in FIGS. 6A to 6D, changes significantly depending on the illumination azimuth. Therefore, as illustrated in FIG. 7A, a flaw is visualized bright in the intermediate image. Noise of the intermediate image is reduced by obtaining the difference between the maximum pixel value and the minimum pixel value in the four images. Regarding the linear flaw of which appearance changes significantly depending on the illumination azimuth, the intermediate image has an improved S/N ratio than those of the four images.

As illustrated in FIGS. 6A to 6D, the appearance (i.e., the pixel value) of the unevenness or the light absorptive contaminant on the image does not change so much depending on the azimuth angle of illumination as in the non-defective area. Therefore, neither the unevenness nor the light absorptive contaminant is clearly visualized in the intermediate image of FIG. 7A.

The intermediate image may be generated using simply the maximum pixel value or the minimum pixel value instead of the difference between the maximum pixel value and the minimum pixel value. The maximum pixel value may be used if the defect is visualized bright, and the minimum pixel value may be used if the defect is visualized dark. If the defect is visualized both bright or dark, the difference between the maximum pixel value and the minimum pixel value is desirably used.

Next, FIG. 7B is an intermediate image generated by the processor 103 via the shading correction and the gradation correction based on the three images of FIGS. 6E to 6G. The intermediate image is generated by obtaining a difference between the maximum pixel value and the minimum pixel value in a pixel group (3 pixels) related to the three images about each pixel (a pixel number or a pixel ID). The pixel values in the non-defective area of the work 11 do not change so much depending on the elevation of illumination. The linear flaw and unevenness have pixel values which change significantly depending on the elevations of illumination as illustrated in FIGS. 6E to 6G. Therefore, as illustrated in FIG. 7B, the linear flaw and the unevenness are visualized bright in the intermediate image.

As illustrated in FIGS. 6E to 6G, the appearance (the pixel value) of the light absorptive contaminant on the image is not changed so much depending on the elevation of illumination in the same manner as in the non-defective area. Therefore, the light absorptive contaminant is not clearly visualized in the intermediate image of FIG. 7B.

The intermediate image may be generated using simply the maximum pixel value or the minimum pixel value instead of the difference between the maximum pixel value and the minimum pixel value. The intermediate image may be generated on the basis of an image at high angle illumination and an image at low angle illumination instead of the three images at the three elevations described above. Since brightness and darkness are reversed in the high angle illumination and in the low angle illumination, the linear flaw and the unevenness are visualized with high contrast in the intermediate image generated based on a difference between the maximum pixel value and the minimum pixel value.

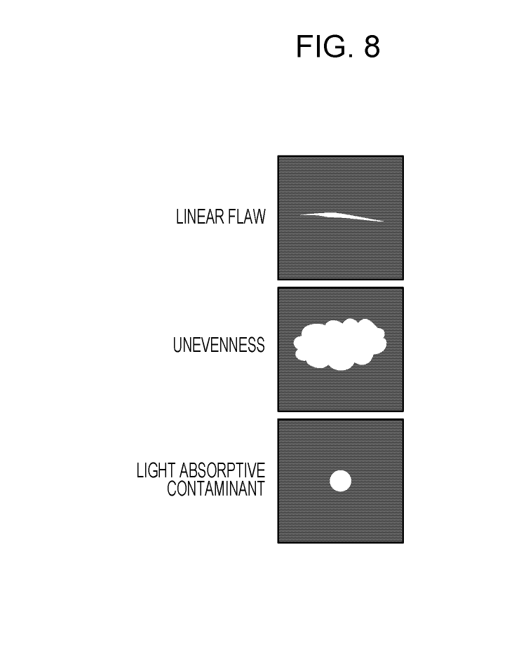

Next, the processor 103 generates an inspection image (step S104). The two intermediate images illustrated in FIGS. 7A and 7B and an image illustrated in FIG. 6H (an image obtained by imaging with all of the LEDs 111 being turned on simultaneously (an “image with all light sources turned on”)) are used for the generation of the inspection image. The processor 103 generates an inspection image by obtaining a difference between the maximum pixel value and the minimum pixel value in a pixel group (3 pixels) related to these three images about each pixel (a pixel number or a pixel ID). FIG. 8 is a schematic diagram illustrating an inspection image.

The appearance (the pixel value) of the non-defective area of the work 11 does not change so much in any of the two intermediate images and the image with all light sources turned on. The linear flaw is visualized bright in the two intermediate images as illustrated in FIG. 7A or 7B, and is not visualized clearly in the image with all light sources turned on as illustrated in FIG. 6H. Therefore, the linear flaw is visualized bright (i.e., has a relatively large pixel value) in the inspection image generated using these three images as illustrated in FIG. 8.

The unevenness is visualized bright in the intermediate image illustrated in FIG. 7B, and is not clearly visualized in the intermediate image of FIG. 7A and in the image with all light sources turned on of FIG. 6H. Therefore, the unevenness is visualized bright as illustrated in FIG. 8 (i.e., has a relatively large pixel value).

The light absorptive contaminant is visualized dark in the image with all light sources turned on illustrated in FIG. 6H, and is not visualized clearly in the two intermediate images illustrated in FIGS. 7A and 7B. Therefore, the light absorptive contaminant is visualized bright as illustrated in FIG. 8 (i.e., has a relatively large pixel value).

In the inspection image generated based on the three images described above, various defects, such as the linear flaw, the unevenness, and the light absorptive contaminant, are visualized (i.e., have relatively large pixel values).

The inspection image may be generated using simply the maximum pixel value or the minimum pixel value instead of the difference between the maximum pixel value and the minimum pixel value of the three images about each pixel. The maximum pixel value may be used if the defect is visualized bright, and the minimum pixel value may be used if the defect is visualized dark. If the defect is visualized both bright or dark, the difference between the maximum pixel value and the minimum pixel value is desirably used.

Next, the processor 103 conducts defect detection (i.e., defectiveness determination) on the appearance of the work 11 on the basis of the inspection image (step S105). Since various defects may be visualized clearly (i.e., may have relatively large pixel values) in the inspection image, various defects are detectable by binarization processing, for example. Since the number of the inspection image as a target of defect detection is one, a high-speed detection is possible.

The defect detection (i.e., defectiveness determination) may be conducted by setting a suitable determination standard (e.g., a threshold) with respect to the result of binarization as described above, or may be conducted by learning many inspection images and calculating scores from feature values thereof. If it requires considerable time and skill for a user to set a defective/non-defective determination standard for each of the various defects, automatic score calculation based on learning as described above is desirable.

Generation of the inspection image is not limited to that using the three images as described above. For example, in a work in which a linear flaw is not generated as a defect, an inspection image may be generated on the basis of two images of the intermediate image illustrated in FIG. 7B and the image with all light sources turned on illustrated in FIG. 6H.

Further, instead of the image with all light sources turned on, an image only at the middle angle illumination may be used, for example. That is, an inspection image may be generated on the basis of an image acquired by the imaging device 102 through isotropic illumination at a specific elevation. Further, for example, an image based on the sum or the average of an image at high angle illumination, an image at middle angle illumination, and an image at low angle illumination may be used. This case may be advantageous in the inspection time because it is unnecessary to acquire the image with all light sources turned on by the imaging device 102.

Further, a non-defective image without a defect may be added to plural images used for the generation of the inspection image. In the image with all light sources turned on of FIG. 6H, the linear flaw and the unevenness may be visualized with a certain degree of contrast in some cases. In this case, contrast of the flaw may become insufficient in the inspection image. Even in such a case, an inspection image of the linear flaw or the unevenness of relatively high contrast may be acquired by adding a non-defective image. If light reflex characteristics of a surface of a non-defective object are uniform, an artificial image related to the non-defective object having an area with a constant pixel value may be used instead of the actual non-defective image.

As described above, according to the present embodiment, an inspection apparatus advantageous for inspection of various defects, for example, can be provided.

### Embodiment Related to Article Manufacturing Method

The inspection apparatus according to the embodiments described above may be used in an article manufacturing method. The article manufacturing method may include a step of inspecting an object using the inspection apparatus, and a step of processing the object inspected in the inspection process. The processing may include at least any one of measurement, processing, cutting, conveyance, building (assembly), inspection and sorting, for example. The method of manufacturing an article according to the present embodiment is advantageous in at least one of performance, quality, productivity and production cost of an article as compared with those of the related art methods.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-194024, filed Sep. 30, 2015, which is hereby incorporated by reference herein in its entirety.

1. An inspection apparatus for performing inspection of an object, the inspection apparatus comprising:
an illumination device configured to perform an anisotropic illumination and an isotropic illumination for the object;
an imaging device configured to image the object illuminated by the illumination device; and
a processor configured to perform processing for the inspection of the object based on an image obtained by the imaging device,
wherein the processor is configured to generate an inspection image based on (i) plural first images obtained by the imaging device while the illumination device respectively performs plural anisotropic illuminations and (ii) a second image obtained by the imaging device while the illumination device performs an isotropic illumination, and perform the processing based on the inspection image.

2. The inspection apparatus according to claim 1, wherein the processor is configured to perform shading correction and gradation correction for the image obtained by the imaging device.

3. The inspection apparatus according to claim 1, wherein the processor is configured to generate an intermediate image based on the plural first images obtained by the imaging device respectively via the plural anisotropic illuminations from corresponding plural azimuths, and generate the inspection image based on the intermediate image.

4. The inspection apparatus according to claim 1, wherein the processor is configured to generate an intermediate image based on plural images obtained by the imaging device respectively via plural isotropic illuminations at corresponding plural elevations, and generate the inspection image based on the intermediate image.

5. The inspection apparatus according to claim 1, wherein the processor is configured to generate the inspection image based on an image obtained by the imaging device via the isotropic illumination at a specific elevation.

6. The inspection apparatus according to claim 5, wherein the processor is configured to generate the inspection image based on an image obtained by the imaging device via an isotropic illumination at all of plural elevations.

7. The inspection apparatus according to claim 1, wherein the processor is configured to perform the processing based on a tolerable condition for a pixel value of the inspection image.

8. The inspection apparatus according to claim 7, wherein the processor is configured to generate the inspection image further based on an image of which each pixel value satisfies the tolerable condition.

9. The inspection apparatus according to claim 3, wherein the processor is configured to generate the inspection image from plural images including the intermediate image based on at least one of a maximum pixel value and a minimum pixel value with respect to each group of pixels corresponding to one another in the plural images.

10. The inspection apparatus according to claim 4, wherein the processor is configured to generate the inspection image from plural images including the intermediate image based on at least one of a maximum pixel value and a minimum pixel value with respect to each group of pixels corresponding to one another in the plural images.

11. A method of manufacturing an article, the method comprising:
performing inspection of an object using an inspection apparatus; and
processing the object, of which the inspection has been performed, to manufacture the article,
wherein the inspection apparatus includes:
an illumination device configured to perform an anisotropic illumination and an isotropic illumination for the object,
an imaging device configured to image the object illuminated by the illumination device, and
a processor configured to perform processing for the inspection of the object based on an image obtained by the imaging device,
wherein the processor is configured to generate an inspection image based on (i) plural first images obtained by the imaging device while the illumination device respectively performs plural anisotropic illuminations and (ii) a second image obtained by the imaging device while the illumination device performs an isotropic illumination, and perform the processing based on the inspection image.

12. An inspection apparatus for performing inspection of an object, the inspection apparatus comprising:
an illumination device configured to perform an illumination from a limited azimuth for the object and an illumination from an unlimited azimuth whose azimuth range is larger than an azimuth range of the limited azimuth;
an imaging device configured to image the object illuminated by the illumination device; and
a processor configured to perform processing for the inspection of the object based on an image obtained by the imaging device,
wherein the processor is configured to perform the processing based on (i) plural first images obtained by the imaging device while the illumination device respectively performs, from the limited azimuth, plural illuminations and (ii) a second image obtained by the imaging device while the illumination device performs an illumination from the unlimited azimuth.

13. A method of manufacturing an article, the method comprising:
performing inspection of an object using an inspection apparatus; and
processing the object, of which the inspection has been performed, to manufacture the article,
wherein the inspection apparatus includes:
an illumination device configured to perform an illumination from a limited azimuth for the object and an illumination from an unlimited azimuth whose azimuth range is larger than an azimuth range of the limited azimuth,
an imaging device configured to image the object illuminated by the illumination device, and
a processor configured to perform processing for the inspection of the object based on an image obtained by the imaging device,
wherein the processor is configured to perform the processing based on (i) plural first images obtained by the imaging device while the illumination device respectively performs, from the limited azimuth, plural illuminations and (ii) a second image obtained by the imaging device while the illumination device performs an illumination from the unlimited azimuth.
